(19) United States
(12) Patent Application Publication
(10) Pub. No.: US 2005/0177628 A1
(43) Pub. Date: Aug. 11, 2005

(54) Computing system deployment method

(75) Inventors: Emarson Victoria, Singapore (SG); Hui Ming Jason Tseng, Singapore (SG); Hwee Hwa Pang, Singapore (SG); Tau Chen Cham, Singapore (SG)

Correspondence Address: CONLEY ROSE, P.C., P. O. BOX 3267, HOUSTON, TX, 77253-3267, US

(73) Assignee: Agency for Science, Technology and Research

(21) Appl. No.: 10/515,133

(22) PCT Filed: May 16, 2002
(86) PCT No.: PCT/SG02/00095

(51) Int. Cl. G06F 15/173

(52) U.S. Cl. 709/220; 709/223

(57) ABSTRACT

Conventional computing systems today, for example enterprise applications, possess multi-tier architectures. Management of the computing systems to maintain architectural system onto which the computing systems are deployed onto, is critical for providing availability of business services to users. When components of a computing system or computing system are moved between two host systems, there is a need to reconfigure a previously configured host system. Thus, the deployment requires complicated procedures that requires specialized training in the computing system being installed as system integrity has to be preserved at all times. Furthermore, a computing system will undergo further component replacements, enhancements and expansion in scale once it becomes operational within the system. Keeping the dependencies and the integrity of a large scale host system becomes problematic as different components of the computing systems are provided by different vendors. Furthermore, the maintenance of inter-connected host systems, computing systems or its components needs to be performed by an administrator who is deploying the systems or computing systems. An embodiment of the invention addresses the foregoing issues by introducing layers and clusters for segregating components of the computing system based on their functionality and services provided respective components. Associations between components are registered in profiles to facilitate dependency tracking. The model provided by the embodiment of the invention allows for structured deployment of the computing system onto a host system. The profiles further facilitate migration of the computing system and its associated components onto another host system without compromising host system integrity.

### FIELD OF INVENTION

The present invention relates generally to a computing system deployment method. In particular, the invention relates to a computing system deployment method for deploying and migrating computing system components.

### BACKGROUND

Conventional computing systems, for example enterprise applications, typically possess multi-tier architectures. Unlike standalone computing systems in the past, such computing systems provide specialized solutions catering to different business aspects within an organization or across geographically distant installations. The elaborate structure of these computing systems gives rise to a vast quantity of heterogeneous back-end computing.

Management of the computing systems in order to maintain architectural integrity and performance of the computing systems is critical for providing availability of business services to users, for example customers.

The aspects of the computing systems typically requiring management includes the deployment and configuration of computing system services, system functionality diagnosis, maintaining the integrity of component dependencies within a computing system and the monitoring and balancing of computing system component loading for improving computing system performance.

In the course of managing the computing systems, a situation requiring components of a computing system to be moved between two host systems residing at different locations may arise. Alternatively, new resources may be made available to the host system within which the computing systems reside in. In both these situations, there is a need to reconfigure a previously configured host system. In most cases, the deployment of a computing system or its components requires complicated procedures that requires specialized training in the computing system being installed as system integrity of the host system has to be preserved at all times.

A computing system typically undergoes several configuration changes and a few versions of its associated components in the course of its life. Once a computing system is deployed within a host system and becomes operational, it will undergo further component replacements, enhancements and expansion in scale.

Maintaining the dependencies and the integrity of a large-scale computing system becomes problematic as different components of the computing system are typically provided by different vendors. Furthermore, maintenance of inter-connected host systems, computing systems or its components needs to be performed by an administrator who is deploying the computing system. In such a situation, the dependencies and inter-connection requirements are provided to the administrator in the form of instructional manuals. Further knowledge of the requirements and limitations of each host system, computing system or its components is dependant on the experience and tacit capability of the administrator.

It is therefore desirable to have a common way of capturing or specifying all these information in a structured way, so that the discovery of dependencies can be automated.

A conventional method of deploying a computing system is to remove a computing system from its current deployed location and to deploy a copy of the computing system in its new environment. The dynamic contents generated during the lifetime of the computing system in its previous location would be manually copied to the new location. This will require the presence of an expert of the computing system to be deployed. The extent of the expert's contribution is to make the necessary changes to allow the system or computing system to function. This however, does not establish compatibility of the computing system with other deployed computing systems. As a result, this may expose the host system to integrity loss.

Another method requires the utilising of a group of experts, for example computing system integrators, to work out a plan for migrating or deploying multi-vendor computing systems and components. Fundamentally, this method is similar to the mentioned method. These methods require experts to oversee and manage the deployment or migration process, leading to high cost, high consumption of time and effort and possibility of future deployment error.

Hence, this clearly affirms a need for a computing system deployment method for migrating and deploying applications and its components.

### SUMMARY

Therefore, in accordance with a first aspect of the invention, there is disclosed a computing system deployment method comprising the steps of:
providing a system layer on a host system;
defining a plurality of system clusters in the system layer;
allocating a plurality of system components into the plurality of system clusters, each system cluster containing one or more system components;
providing a service layer on the host system;
defining a plurality of service clusters in the service layer;
allocating a plurality of service components into the plurality of service clusters, each service cluster containing one or more system components; and
associating each service component in each service cluster with one or more system components.

In accordance with a second aspect of the invention, there is disclosed a computing system deployment model comprising:
a system layer provided on a host system;
a plurality of system clusters defined in the system layer;
a plurality of system components allocated into the plurality of system clusters, each system cluster containing one or more system components;
a service layer provided on the host system;
a plurality of service clusters defined in the service layer; and
a plurality of service components allocated into the plurality of service clusters, each service cluster containing one or more system components,
wherein each service component in each service cluster is associated with one or more system components.

### BRIEF DESCRIPTION OF THE DRAWINGS

Embodiments of the invention are described hereinafter with reference to the following drawings, in which:

FIG. 1 shows a block diagram representing a host system containing a service layer, a system layer, a resource layer, a resource map and a service map;

FIG. 2 shows a block diagram representing the service layer of FIG. 1 with a plurality of service components grouped in service clusters;

FIG. 3 shows a block diagram representing the system layer of FIG. 1 with a plurality of system components grouped in system clusters;

FIG. 4 shows a block diagram representing the system layer of FIG. 1 with a plurality of resource components grouped in resource clusters;

FIG. 5 shows a block diagram representing a service profile associated with each service component of FIG. 2;

FIG. 6 shows a block diagram representing a system profile associated with each system component of FIG. 3;

FIG. 7 shows a block diagram representing a resource profile associated with each resource component of FIG. 4;

FIG. 8 shows a block diagram representing a cluster profile associated with the service cluster of FIG. 2, the system cluster of FIG. 3, and the resource cluster of FIG. 4;

FIG. 9 shows a block diagram representing the resource map of FIG. 1; and

FIG. 10 shows a block diagram representing the service map of FIG. 1.

### DETAILED DESCRIPTION

A computing system deployment method for addressing the foregoing problems is described hereinafter.

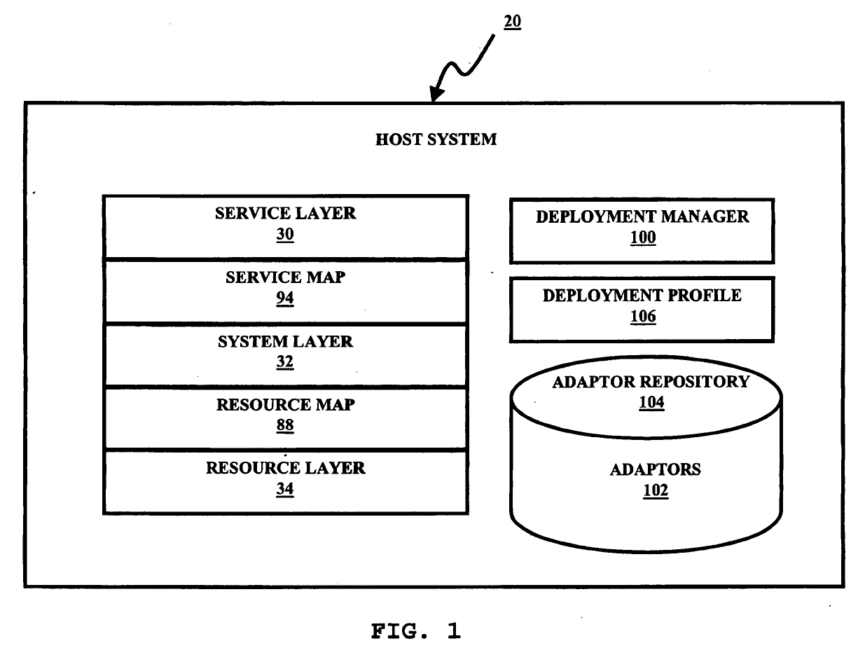

An embodiment of the invention, a computing system deployment method (not shown) is described with reference to FIG. 1, which shows a block diagram representing a host system 20.

The computing system deployment method is preferably for deploying a computing system onto the host system 20, the host system being computer-based and typically comprising a plurality of geographically dispersed sub-systems. A plurality of components, hardware and software, resides within the host system 20. These components are organised into one of service layer 30, system layer 32 and resource layer 34 within the host system 20 as shown in FIG. 1.

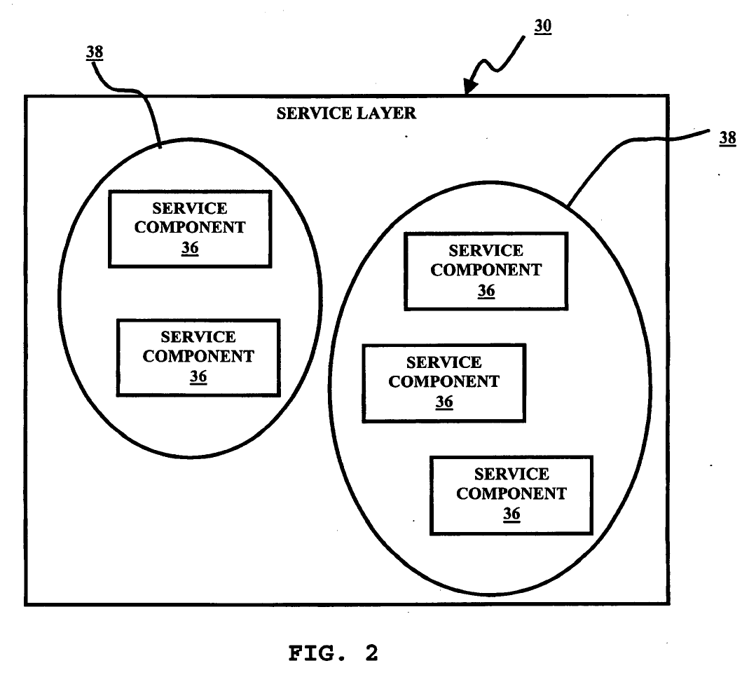

The service layer 30 contains a plurality of service components 36 as shown in FIG. 2. These service components 36 may or may not be supplied by the vendor of the computing system. In the service layer 30, the service components 36 are grouped into service clusters 38. Each service cluster 38 contains service components 36 relating to the computing system. The service components 36 contained in the service layer 30 provide for one or more of application-specific, vendor-specific or domain-specific services which include providing service-related contents, for example, web-contents and user account data.

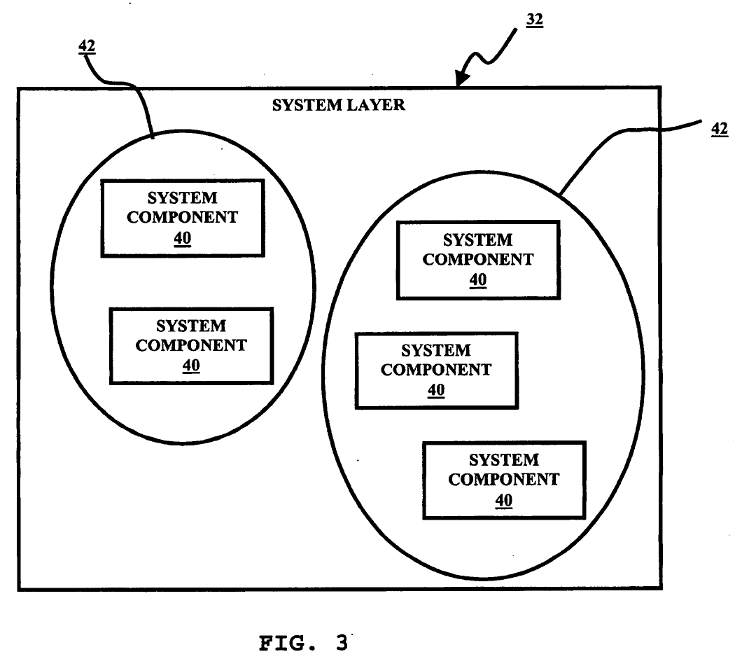

FIG. 3 shows a plurality of system components 40 being allocated to the system layer 32. These system components 40 comprises software system resources, for example, servers and system libraries, and are for providing computing system based resources and services to other components within the host system 20. These system components 40 include, for example, DNS servers, FTP servers, system libraries, file systems, Windows registries and key repositories. In the system layer 32, the system components 40 are grouped into system clusters 42 based on the function of each system component 40.

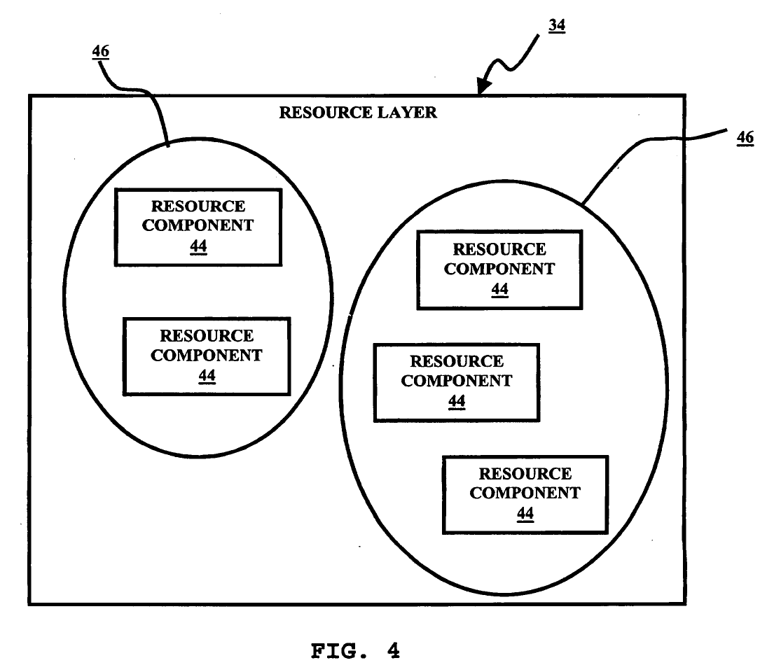

Allocated in the resource layer 34 are resource components 44 as shown in FIG. 4. Each resource component 44 represents physical hardware that is associated with a computing node or a virtual device representing the physical hardware. Examples of hardware represented by resource components 44 include computing servers, network cards, hard disks, memory modules, firewalls, routers and switches. These resource components 44 are grouped into resource clusters 46 in the resource layer 34. Each resource cluster 46 contains resource components 44 having similar functions. The resource clusters 46 include, for example, a firewall cluster, a network router cluster, a network switch cluster, a computing server cluster and a storage cluster.

The service components 36, the system components 40, and the resource components 44 corresponding to and being grouped within the service cluster 38, the system cluster 42 and the resource cluster 46, can be further grouped into sub-clusters (not shown). For example, the service components 36 within a service cluster 38 are further grouped into sub-clusters based on domain requirements, with each sub-cluster of service components 36 providing service support to other service components 36 within a particular domain.

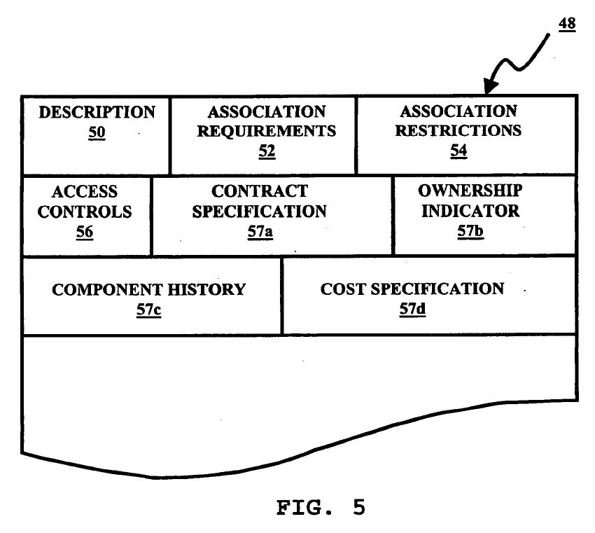

Associated with each service component 36 is a service profile 48 as shown in FIG. 5. Referring to FIG. 5, which shows a block diagram representing the service profile 48 associated with each service component 36, the service profile 48 contains a description 50 of the service component 36, a list of association requirements 52 indicating system components 40 required for associating with the service component 36, and a list of association restrictions 54 indicating other components, for example the service components 36, that are in conflict with and have been prohibited from accessing the service component 36 that the service profile 48 is associated with.

The service profile 48 further contains a list of access controls 56 specifying the ability of a service component 36 contained in another service cluster 38 to access the service component 36 with which the service profile 48 is associated therewith and vice-versa. The access controls 56 are conventionally provided by the vendors of the service components 36 to avoid association of the service components 36 supplied by one vendor from accessing or being accessed by service components 36 supplied by another vendor.

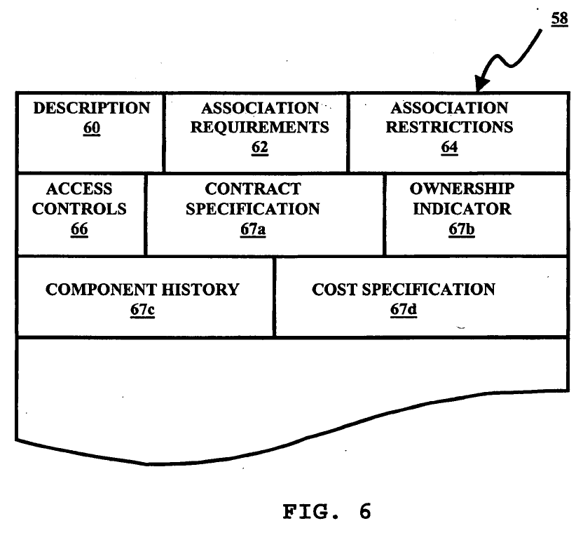

A system profile 58 is associated with each system component 40 as shown in FIG. 6. Referring to FIG. 6, which shows a block diagram representing the system profile 58 associated with each system component 40, the system profile 58 contains a description 60 of the system component 40, a list of association requirements 62 indicating the association of each system component with other resource components 44 and other system components 40 for association therewith, a list of association restrictions 64 indicating other components, for example the resource components 44 and other system components 40, that are in conflict with and have been prohibited from accessing the system component 40 that the system profile 58 is associated therewith.

The system profile 58 further contains a list of access controls 66 specifying the ability of the resource components 44 or system components 40 contained in another system cluster 42 to access the system components 40 with which the system profile 58 is associated and vice-versa. The access controls 66 are conventionally provided by the vendors of the system components 40 to avoid association of the system components 40 supplied by one vendor from accessing or being accessed by system components 40 supplied by another vendor.

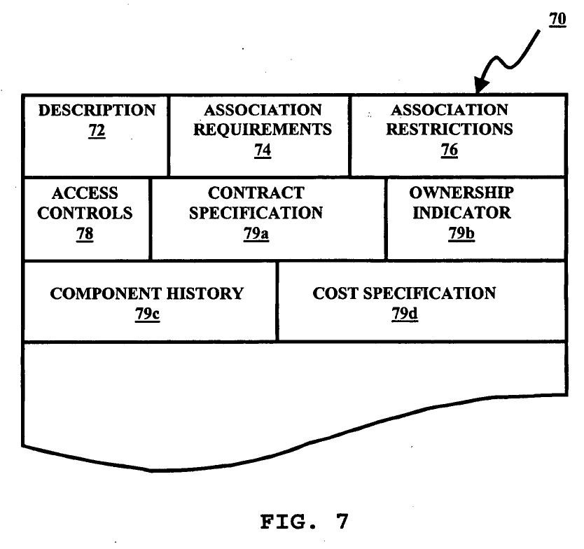

A resource profile 70 is associated with each resource component 44 as shown in FIG. 7. Referring to FIG. 7, which shows a block diagram representing the resource profile 70 associated with each resource component 44, the resource profile 70 contains a description 72 of the resource component 44, a list of association requirements 74 indicating the association of one resource component 44 with other resource components 44 for association with, and a list of association restrictions 76 indicating other resource components 44 prohibited from associating with the resource component 44 associated with the resource profile 70.

The resource profile 70 further contains a list of access controls 78 specifying the ability of a resource component 44 contained in another resource cluster 70 to access the resource component 44 with which the resource profile 70 is associated therewith and vice-versa. The access controls 78 are conventionally provided by the vendors of the resource components 70 to avoid association of the resource components 44 supplied by one vendor from accessing or being accessed by resource components 44 supplied by another vendor.

Each of the service profiles 48, system profiles 58 and resource profiles 70 contains one of application-specific, vendor-specific or domain-specific data (not shown) for facilitating customisation of the computing system deployment method. Preferably, each of the service profiles 48, system profiles 58 and resource profiles 70 further contains a profile security envelope (not shown) for protecting the contents of the service profiles 48, system profiles 58 and resource profiles 70 from unauthorised access thereto. Access to the contents of the service profiles 48, system profiles 58 and resource profiles 70 is permitted only when a valid authentication (not shown) is provided in accordance to the profile security envelope. The profile security envelope further facilitates implementation of access policies for different users.

The corresponding association restrictions 54/64/76 of each of the service profile 48, system profile 58 and resource profile 70 further provide information on potential and known conflicts. The information on the conflicts allows the conflicts to be properly managed or alleviated during the deployment of the computing system.

The corresponding access controls 56/66/78 of each of the service profile 48, system profile 58 and resource profile 70 may be utilised for marketing, political, security or operational reasons. The access controls 56/66/78 allows for further policies on access and associations to be provided therein.

Further specified in each of the service profile 48, system profile 58 and resource profile 70 is a list of corresponding contract specification 57a/67a/79a, a list of corresponding ownership indicator 57b/67b/79b, a list of corresponding component history 57c/67c/79c, and a list of corresponding cost specifications 57d/67d/79d as shown in FIGS. 5 to 7.

The contract specification 57a/76a/79a states the information to be provided by a service component 36, system component 40 or resource component 44 by another corresponding service component 36, system component 40 or resource component 44 respectively for the accessing of the same former.

An application of the contract specification 57a/67a/79a is illustrated using a hypertext transfer protocol (HTFP) server (not shown). This HTTP server example, an Apache HTTP server's (not shown) system component 40 requires a valid alias and a root directory location to be specified for access thereto. The valid alias and root directory location requirements are stated in the contract specification 67a of the system profile 58 associated with the system component 40 of the Apache HTTP server. Therefore, a service component 36 of an Enterprise server (not shown) requiring access to the system component 40 of the Apache HTTP server has to be provided with information required by the contract specification 67a thereof. The service component 36 of the Enterprise server then provides the Apache HTTP server with the required valid alias and the root directory location to the system component 40 of the Apache HTTP server for access of the same thereby in accordance to the association requirements 52 of the service profile 48 of the service component 36.

The ownership indicator 57b/76b/79b indicates one or more owners of the service component 36, system component 40 or resource component 44 and the relative priority that each owner has over the respective service component 36, system component 40 or resource component 44 based on the configuration of the deployment. The owner is one or more of any combination of a system including the host system 20, a cluster including the service cluster 38, system cluster 42 and resource cluster 46, and a component including the service component 36, system component 40 and resource component 44.

The component history 57c/67c/79c of a component, for example the service component 36, system component 40 or resource component 44, tracks the current and past configurations the component is deployed upon. The component history 57c/67c/79c further reflects the dependency of other components on the component. The component history 57c/67c/79c is further used for restoring and archiving of deployed computing systems. This enables any corruption to the computing system or the components therein to be rectified by enabling redeployment or restoration of the computing system to its most recent pre-corrupted state.

The ownership indicator 57b/67b/79b and component history 57c/67c/79c are applicable within a system, for example, System A (not shown). In this example, Component B, a system component 40, is configured using a first deployment configuration for use by System A. When another system, for example System C (not shown), requires Component B (not shown) to be configured using a second deployment configuration for use thereby, the component history 67c of Component B is consulted upon. The component history 67c indicates that System A is depended thereon and configured under the first deployment configuration. Next, the ownership indicator 76b is checked for any configuration conflict. If the first deployment configuration is in conflict with System B or the second deployment configuration is in conflict with System A, the relative priorities of both System A and System B are compared. If System A is declared as the main owner of Component B within the ownership indicator 76b thereof and therefore has a higher priority relative to System B, the first deployment configuration is maintained and System B is restricted from configuring Component B for use thereby. However, if there are no configuration conflicts between System C, Component B and System A, the association restrictions 64 of Component B is checked to ensure that System C is not prohibited from accessing Component B.

The list of cost specifications 57d/67d/79d specifies the corresponding cost of using each of the service components 36, system components 40 and resource components 44. The cost of using a component includes virtual memory usage (for example a random access memory or RAM), physical storage usage (for example a hard disk drive), the physical storage expansion requirements with respect to time and the like system resource requirements. The cost specifications 57d/67d/79d allow an administrator of a system to decide upon the viability of installing a component or a cluster of components while considering the current and future impact on system resource requirements if the component is installed.

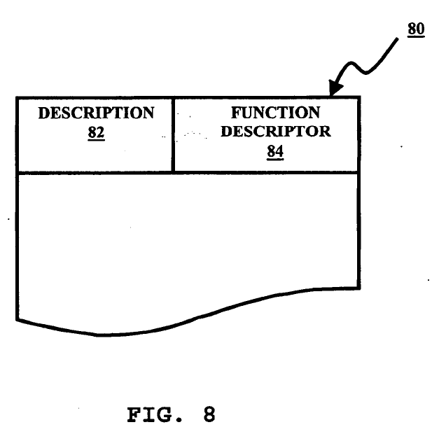

Referring to FIG. 8, a cluster profile 80 is associated with each of service cluster 38, system cluster 42 and resource cluster 46. The cluster profile 80 contains a description 82 of an associated cluster, and a function descriptor 84 defining the function of corresponding service components 36, system components 40 and resource components 44 contained therein. This allows any one of service component 36, system component 40 or resource component 44 having similar functions to be grouped together in a single cluster.

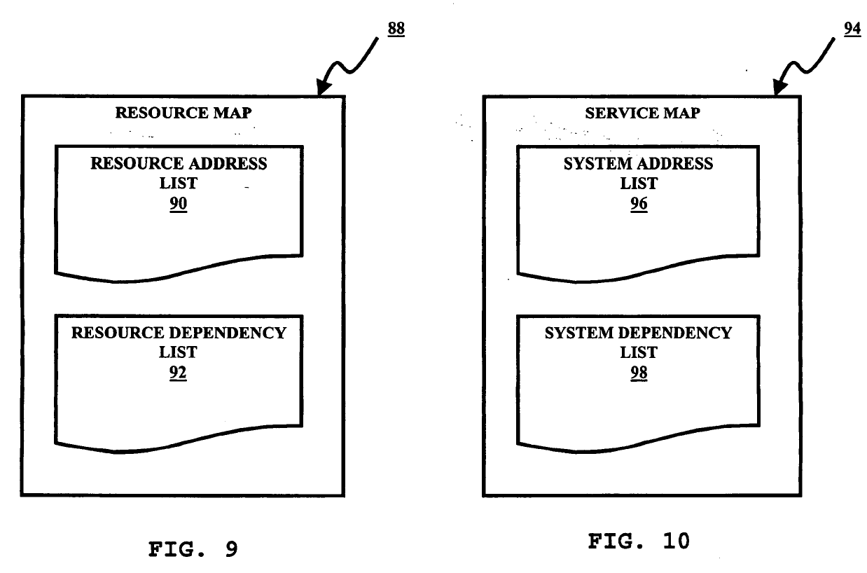

A resource map 88 is associated with the resource layer 34 as shown in FIG. 1. FIG. 9 shows a block diagram representing the resource map 88. Referring to FIG. 9, the resource map 88 is shown containing a resource address list 90 indicating the locations of all the resource components 44 allocated in the resource layer 34 and a resource dependency list 92 indicating the system components 40 associated with each resource component 44.

A service map 94 is associated with the service layer 30 as shown in FIG. 1. FIG. 10 shows a block diagram representing the service map 94. Referring to FIG. 10, the service map 94 is shown containing a system address list 96 indicating the locations of all the system components 40 allocated to the system layer 36 and a system dependency list 98 indicating the service components 36 associated with each system component 40.

Prior to the deployment of the computing system onto a host system 20, a deployment manager 100 residing in the host system 20, as shown in FIG. 1, analyses the computing system and the service components 36 associated therewith. The service components 36 are installable service components for deployment onto the host system 20. The deployment manager 100 is preferably operated by an administrator of the host system 20.

The association requirements 52 for each service component 36 are obtained from the associated service profile 48. The system components 40 available in the system layer 32 of the host system 20 are matched with the association requirements 52 of the service components 36. If any of the system components 40 specified in the association requirements 52 are not available on the host system 20, the administrator is immediately prompted for further instructions. If the association requirements 52 are satisfied, the association restrictions 62 of the required system components 40 are checked for any conflicts between the system components 40 and service components 36 to be installed.

Availability of information required is assessed in accordance to the corresponding contract specification 57a/67a of the service components 36 and system components 36. If information is inadequate, the deployment manager 100 prompts the administrator to provide the deployment manager 100 with more information.

If no conflict arises, the deployment manager 100 proceeds to deploy the computing system onto the host system 20. The host system 20 typically includes one or more physical systems deployed within or across multiple geographical locations, for example, an instance of a single computing system having multiple computing nodes. First, a new service cluster 38 is generated in the service layer 30 to accommodate the service components 36 provided by the computing system if the required service cluster 38 is unavailable. A cluster profile 80 is also generated for the new service cluster 38 for association with the newly generated service cluster 38. Next, the service components 36 and their associated service profiles are deployed onto the service layer 30. The description 82 of the new service cluster 38 and the function descriptor 84 within the cluster profile 80 are updated in accordance to the information contained in the service profiles 48 of the service components 36.

Based on the description 50 of the service components 36, the deployment manager identifies an adaptor 102 required for deploying the service components 36. The adaptor 102 shown in FIG. 1 is a computing system-specific module for performing the actual deployment of the service components 36. If the adaptor 102 is not supplied with the computing system, the deployment manager 100 proceeds to use a generic adaptor 102 contained in an adaptor repository 104 of the host system 20 shown in FIG. 1. Alternatively, the adaptor 102 is downloadable from a system network or the Internet maintained by a component vendor or a third party component and adaptor supplier. Once the adaptor 102 is identified and present, the deployment manager 100 invokes the adaptor 102 to proceed with the deployment of the service components 36 of the computing system onto the host system 20. The adapter 102 further performs checks and operations to fine-tune system performance and the like vendor specific operations. Once the service components 36 have been deployed onto the service layer 30, the deployment manager 100 proceeds to associate the service components 36 with the system components 40 based on the corresponding association requirements 52 and the contract specification 57a. The ownership indicator 57b of each service component 36 is also assessed for any deployment conflict.

Next, the service address list 96 of the service map 94 is updated with the locations of the newly deployed service components 36 within the host system 20, for example, an instance of the aforementioned computing system with multiple computing nodes. The service dependency list 98 of the service map 94 is also updated with the new associations between the service components 36 and the system component 40. All activities undertaken by the deployment manager 100 to deploy the computing system onto the host system 20 is recorded in a deployment profile 106. The component history 57c/67c/79c of each corresponding service components 36, system components 40 and resource components 44 are updated with the new associations and configurations derived therefrom.

The deployment manager 100 allows the administrator to test the viability of configuring and deploying a specific computing system onto the host system 20. Furthermore, the cost specifications 57d/67d/79d allows the administrator to assess current and future resource requirements for the deployment. This preventive approach is preferred over a rectification approach of trying to solve a compatibility problem only after the deployment of the computing system onto the host system 20.

During the life of the computing system, changes are made to service components 36, the system components 40, resource components 44 and associations therebetween. The request for these changes are monitored and verified by the deployment manager 100 which readily updates one or more of the affected service profiles 48, system profiles 58, resource profile 70, cluster profile 80, resource map 88 and service map 94.

When a need arises for a component (for example the service component 36, system component 40 or resource component 44), the components within a cluster (the service cluster 38, system cluster 42 or resource cluster 46), a cluster, or a computing system to be migrated from the host system 20 to a new system (not shown), system integrity has to be maintained for both the host system 20 and the new system. The first phase of migrating the computing system requires that all its service components 36 and its associated components be duplicated on the new system. Using the cluster profile 80 of the service cluster 38 containing the service components 36 of the computing system, the associated service profiles 48 and system profiles 58 are used for duplicating the configuration of the computing system in the host system 20 onto the new system. This allows any changes made to the service components 36 of the computing system to be maintained in the new system without the need for manual reconfiguration of a fresh deployment of the computing system onto the new system.

Once the computing system is deployed onto the new system, the second phase of migrating the computing system requires the removal of the service components 36 residing in the host system 20. In order for the system integrity of the host system to be maintained, the deployment manager has to utilise the information stored within the deployment profile 106 of the computing system and the component history 57c/67c/79c of each corresponding service component 36, system component 40 and resource component 44. Furthermore, removal of the computing system requires information from the service map 94, the resource map 88 and the ownership indicators 57b/67b/79c. This prevents components associated with other computing systems from being removed during the migration process.

In the foregoing manner, a computing system deployment method is described according to an embodiment of the invention for addressing the foregoing disadvantages of conventional computing system deployment methods. Although only one embodiment of the invention is disclosed, it will be apparent to one skilled in the art in view of this disclosure that numerous changes and/or modification can be made without departing from the scope and spirit of the invention.

1. A computing system deployment hod method comprising steps of:
providing a system layer on a host system;
defining a plurality of system clusters in the system layer;
allocating a plurality of system components to the plurality of system clusters, each system cluster containing at least one system components;
providing a service layer on the host system;
defining a plurality of service clusters in the service layer;
allocating a plurality of service components to the plurality service clusters, each service cluster containing at least one service component; and
associating each service component in each service cluster with at least one system component.

2. The computing system deployment method as in claim 1, further comprising the steps of:
associating a service profile with each service component, the service profile comprising a description of the service component, at least one association requirement, at least one association restriction, and at least one contract specification, the contract specification indicating at least one parameter required by the services component for association thereto;
associating a service cluster profile with each service cluster, the service cluster profile comprising a description of the service components allocated to each service cluster.

3. The computing system deployment method as in claim 2, further comprising the steps of:
providing a resource layer on the host system;
defining a plurality of resource clusters in the resource layer;
allocating a plurality of physical components to the plurality of physical resource clusters, each physical resource cluster containing at least one physical component; and
associating each physical component in each physical resource cluster with at least one system component.

4. The computing system deployment method as in claim 3, further comprising the step of:
associating a system profile with each system component, the system profile comprising a description of the system component, at least one association requirement, at least one association restriction, and at least one contract specification, the contract specification indicating at least one parameter required by the service component for association thereto.

5. The computing system deployments method as in claim 4, further comprising the steps of:
associating a service cluster profile with each service cluster, the service cluster profile describing the general function of the service components allocated to each service cluster;
associating a system cluster profile with each system cluster, the system cluster profile describing the general function of the system components allocated to each system cluster; and
associating a resource cluster profile with each resource cluster, the resource cluster profile describing the general function of the resource components allocated to each resource cluster.

6. The computing system deployment method as in claim 5, further comprising the step of:
associating a resource profile with each resource component, the resource profile comprising a description of the resource component, at least one association requirement, at least one association restriction, and at least one contract specification, the contract specification indicating at least one parameter required by the service component for association thereto.

7. The computing system deployment method as in claim 6, further comprising the steps of:
providing a resource map associated with each resource layer, the resource map indicating to physical locality of the resource components within the host system and the system components associated with each resource component; and
providing a service map associated with the service layer, each service map indicating the physical locality of each system component within the host system and the service components associated with each system component.

8. The computing system deployment method as in claim 7, further comprising the steps of:
providing a computing system, the computing system comprising a plurality of deployable service components for deployment on the host system;
analysing the service profile of each deployable service component of the computing system, the service profile indicating the association requirements of each deployable service component, the association requirements identifying the service components and system components required to the host system; and
discovering on the host system the availability of the service components and the system components required by the deployable service components.

9. The computing system deployment method as in claim 8, further comprising the step of:
analysing the association restrictions and contract specification of the service components and the system components required by each deployable service component.

10. The computing system deployment method as in claim 9, further comprising the steps of:
discovering on the host system the availability of the system components and the resource components required by each system component for association with each deployable service component; and
analysing the association requirements, association restrictions and contract specification of each system component and each resource component required by the system components for association with each deployable service component.

11. The computing system deployment method as in claim 10, further comprising the step of:
deploying the deployable service components in the service layer of the host system;
allocating each deployable service component to service clusters based on the description in the service profile of the deployable service component;
establishing an association between each deployable service component and at least one of service components and system, components;
updating the association between the service components in the service layer and the system components in the system layer;
updating the association between the system components in the system layer and the resource components in the resource layer; and
updating a deployment profile in the host system based on the deployment of the deployable service component and the updates of associated therein.

12. A computing system deployment model comprising:
a system layer provided on a host system;
a plurality of system clusters defined in the system layer;
a plurality of system components allocated to the plurality of system clusters, each system cluster containing at least one system component;
a service layer provided on the host system;
a plurality of service clusters defined in the service layer; and
a plurality of service components allocated to the plurality of service clusters, each service cluster containing at least one service component,
wherein each service component in each service cluster is associated with at least one system component.

13. The computing system deployment model as in claim 12, further comprising:
a service profile for association with each service component, the service profile comprising a description of the service component, at least one association requirement, at least one association restriction, and at least one contract specification, the contract specification indicating at least one parameter required by the service component for association thereto;
a service cluster profile for association with each service cluster, the service cluster profile comprising a description of the service components allocated to each service cluster.

14. The computing system deployment model as in claim 13, further comprising:
a resource layer provided on the host system;
a plurality of resource clusters defined in the resource layer; and
a plurality of physical components allocated to the plurality of physical resource clusters, each physical resource cluster containing at least one physical component,
wherein each physical component in each physical resource cluster is associated with at least one system component.

15. The computing system deployment model as in claim 14, further comprising:
a system profile associated with each system component, the system profile comprising a description of the system component, at least one association requirement, at least one association restriction, and at least one contract specification, the contract specification indicating at least one parameter required by the service component for association thereto.

16. The computing system deployments model as in claim 15, further comprising:
a service cluster profile for association with each service cluster, the service cluster profile describing the general function of the service components allocated to each service cluster;
a system cluster profile for association with each system cluster, the system cluster profile describing the general function of the system components allocated to each system cluster; and
a resource cluster profile for association with each resource cluster, the resource cluster profile describing the general function of the resource components allocated to each resource cluster.

17. The computing system deployment model as in claim 16, further comprising:
a resource profile for association with each resource component, the resource profile comprising a description of the resource component, at least one association requirement, at least one association restriction, and at least one contract specification, the contract specification indicating at least one parameter required by the service component for association thereto.

18. The computing system deployment model as in claim 17, further comprising:
a resource map for association with each resource layer, the resource map indicating the physical locality of the resource components within the host system and the system components associated with each resource component; and
a service map for association with the service layer, each service map indicating the physical locality of each system component within the host system and the service components associated with each system component.

19. The computing system deployment model as in claim 18, further comprising:
a computing system, the computing system comprising a plurality of deployable service components for deployment onto the host system,
wherein the service profile of each deployable service component of the computing system indicates the association requirements of each deployable service component, the association requirements identifying the service components and system components required on the host system for deployment thereby.

20. The computing system deployment model as in claim 19, further comprising the means for:
discovering on the host system the availability of the service components and the system components required by the deployable service components.

21. The computing system deployment model as in claim 20, further comprising the means for:
analysing the association restrictions and the contract specification of the service components and the system components required by each deployable service component.

22. The computing system deployment model as in claim 21, further comprising the means for:
discovering on the host system the availability of the system components and the resource components required by each system component for association with each deployable service component; and
analysing the association requirements, association restrictions, and contract specification of each system component and each resource component required by the system components for association with each deployable service component.

23. The computing system deployment method as in claim 22, further comprising the means for:
deploying the deployable service components in the service layer of the host system;
allocating each deployable service component to service clusters based on the description in the service profile of the deployable service components;
establishing an association between each deployable service component and at least one of service components and system components;
updating the associations between the service components in the service layer and this system components in the system layer;
updating the associations between the system components in the system later and the resource components in the resource layer; and
updating a deployment profile in the host system based on the deployment of the deployable service components and the updates of association therein.
